(19) United States
(12) Patent Application Publication
(10) Pub. No.: US 2020/0210235 A1
(43) Pub. Date: Jul. 2, 2020

(54) EFFICIENT METRIC TRACKING OF UNITS IN A CLIENT APPLICATION

(71) Applicant: MZ IP Holdings, LLC, Palo Alto, CA (US)

(72) Inventor: Detmar Peterke, San Carlos, CA (US)

(21) Appl. No.: 16/708,158

(22) Filed: Dec. 9, 2019

Related U.S. Application Data
(60) Provisional application No. 62/785,360, filed on Dec. 27, 2018.

(51) Int. Cl. G06F 9/50

(52) U.S. Cl. CPC G06F 9/50; G06F 9/455

(57) ABSTRACT

A pool of units of a client application that satisfy one or more targeting rules associated with a primary unit is identified, wherein the pool of units includes a subset of a total number of units of the client application. A determination as to whether a first metric for a first unit of the pool of units satisfies one or more target criteria associated with the primary unit is made. In response to determining that the first metric satisfies the one or more target criteria, the first unit of the pool of units is selected as a target unit for the primary unit.

### CROSS-REFERENCE TO RELATED APPLICATIONS

This application claims the benefit of U.S. Provisional Patent Application No. 62/785,360, filed Dec. 27, 2018, the entire contents of which are incorporated by reference herein.

### BACKGROUND

The present disclosure relates generally to tracking of metrics associated with units in a client application. The client application may track various metrics associated with the units of the client application and the relationships of the units with one another. For example, the client application may track distances between neighboring units of a video game application, distances to landmarks in a navigation application, proximity to users of a social media application, etc. As the number of units of the client application increases, it becomes increasingly difficult to efficiently track metrics associated with the users of the client application.

### DESCRIPTION OF THE DRAWINGS

FIG. 1 is a schematic diagram of an example metric tracking system for tracking metrics of pools of units of a client application.

FIG. 2 is an illustration of an example of a metric tracking system assigning units of a client application to pools of units, in accordance with embodiments of the disclosure.

FIG. 3A is an illustration of an example of a metric tracking system tracking metrics of a first unit of a client application, in accordance with embodiments of the disclosure.

FIG. 3B is an illustration of an example of a metric tracking system tracking metrics of a second unit of a client application, in accordance with embodiments of the disclosure.

FIG. 3C is an illustration of an example of a metric tracking system tracking metrics of a third unit of a client application, in accordance with embodiments of the disclosure.

FIG. 3D is an illustration of an example of a metric tracking system tracking metrics of a fourth unit of a client application, in accordance with embodiments of the disclosure.

FIG. 4 is a block diagram illustrating an example method of tracking metrics of a pool of units, in accordance with embodiments of the disclosure.

FIG. 5 is a block diagram illustrating an example method of identifying one or more pools of units of a client application based on target rules of a primary unit, in accordance with embodiments of the disclosure.

FIG. 6 is a block diagram of an example computing device.

### DETAILED DESCRIPTION

Aspects of the disclosure relate to tracking metrics of units of a client application. The client application may track various metrics that are associated with each of the units. Metrics may correspond to any numerical value that may be associated with units of the client application (also referred to as “application” hereafter). For example, in a video game application, the application may track the virtual distance from a primary unit, such as a user of the application's unit, and other targetable units within the environment of the video game application. When the number of units of the client application is relatively small, the tracking of metrics associated with the units may be implemented using a more simplistic approach. For example, the video game application may determine whether each unit of the game is targetable by the primary unit, and then determine the distance from the primary vehicle to each targetable unit. The video game application may then select a particular unit as a target unit for the primary unit based on one or more target criteria. For example, if the target criterion is the smallest virtual distance from the primary unit, then the target unit would be the closest targetable unit to the primary unit.

However, as the number of units of the client application increases, this simplistic approach to metric tracking becomes less efficient. For example, in a video game application having 10,000 units, the video game application may have to determine whether each of the 10,000 units is targetable by the primary unit, then determine the distance between the primary unit and each of the targetable units. This may result in thousands of calculations being performed by the client application, consuming computing bandwidth and decreasing the performance of the client application.

Aspects of the disclosure remedy the above and other deficiencies by assigning units of a client application to one or more pools of units to efficiently track metrics associated with the units. Processing logic executing a client application may generate one or more pools of units of the client application. Each of the pools may have one or more rules that determine which units from the client application are included in each of the pools. For example, in a video game application, the processing logic may generate a first pool having a rule that units included in the first pool are land units, a second pool having a rule that units included in the second pool are air units, a third pool having a rule that units included in the third pool are friendly units, etc.

As units are added to the application, each unit may be assigned to one or more of the pools based on properties associated with each unit. For example, a unit that is a land unit may be assigned to the first pool, a unit that is an air unit may be assigned to the second pool, and a unit that is a friendly unit may be assigned to the third pool. Depending on the properties of the unit and the rules associated with each of the pools, units may be assigned to multiple pools of units.

The processing logic may identify a primary unit of the client application. For example, in a video game application, the processing logic may identify a unit of the user of the video game application as the primary unit. The primary unit may have one or more target rules that may be used to select one or more pools of units as including potential targets for the primary unit. For example, the primary unit may have one or more target rules that indicate the target for the primary unit should be the closest land unit to the primary unit. Accordingly, the processing logic may determine that the first pool of units (e.g., the pool including land units) includes potential targets for the primary unit.

Upon determining which pool(s) of units to use, the processing logic may track metrics of each unit of the pool(s) of units. For example, upon selecting the first pool of units, the processing logic may track the distance between the units of the first pool of units and the primary unit. The processing logic may track the metrics by scanning each unit in a determined order to determine the metric for each unit of the pool of units. For example, the processing logic may sequentially determine the metric for each unit in the pool of units. In embodiments, the processing logic may iteratively determine the metrics for each unit of the pool of units in the determined order to update the metrics for each unit.

While tracking the metrics for the units of the pool of units, the processing logic may select a target unit for the primary unit based on the one or more target criteria. For example, if the target criteria indicate that the target for the primary unit should be the closest unit from the pool of units, then the processing logic may select the closest unit to the primary unit as the target unit. Selecting a unit of the client application as a target unit may cause the primary unit to target the selected target unit. For example, in a video game application, selecting a unit as the target unit may cause the primary unit to attack the target unit. In another example, in a navigation application, selecting a unit as the target unit may cause the primary unit to identify the target unit as a destination for the primary unit.

Upon determining the metric for another unit of the pool of units, the processing logic may compare the metric of the new unit to the metric of the currently selected target unit. If the metric for the other unit satisfies the target criteria, then the processing logic may replace the currently selected target unit with the other unit as the target unit. For example, if the other unit is closer to the primary unit than the currently selected target unit, then the currently selected target unit may be replaced with the other unit as the target unit.

By tracking metrics for units of a client application by using pools of units, the number of metrics being tracked by the client application is reduced. For example, rather than tracking metrics for every unit of a client application, the client application may track a subset of units of the client application that are assigned to a particular pool. Therefore, computing overhead that may have been dedicated towards tracking metrics of all the units of the application may be used towards other processes, improving the performance of the client application.

Although examples of the disclosure may be described in the context of a video game application, such examples are for illustrative purposes only. Aspects of the disclosure may be utilized by any client applications that benefit from efficient tracking of metrics. For example, aspects of the disclosure may be used by a navigation application to track distances from a user's vehicle to nearby landmarks/locations. In another example, aspects of the disclosure may be used by a social media application to locate neighboring users in the vicinity of a user of the social media application. In a further example, aspects of the disclosure may be utilized by autonomous vehicle applications to efficiently track nearby pedestrians, vehicles, obstacles, etc.

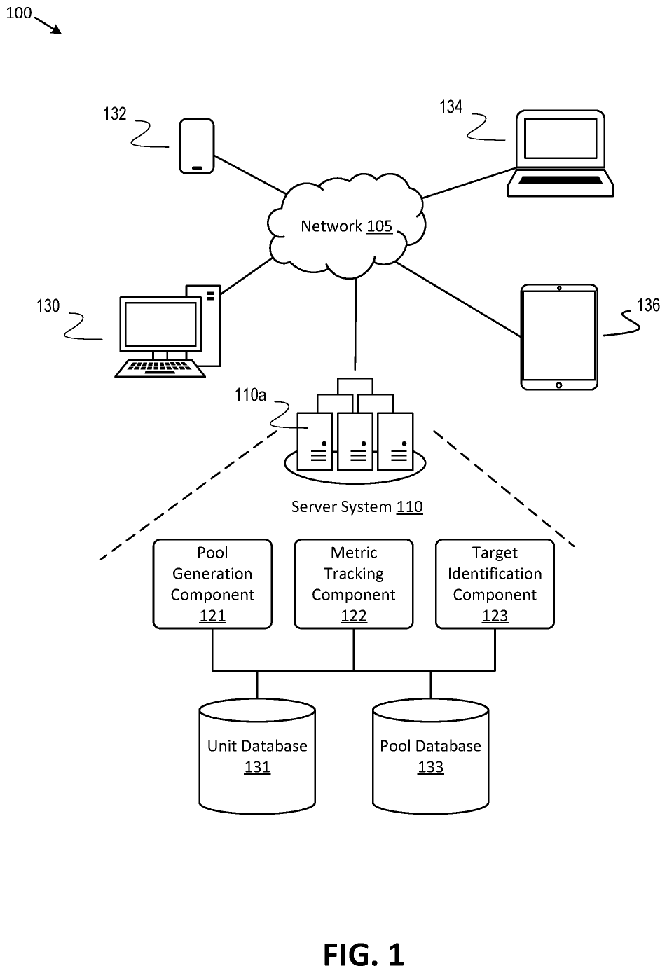

FIG. 1 is a schematic diagram of an example metric tracking system 100 for tracking metrics of units of a client application. A server system 110 including one or more servers 110a provides functionality for operating and managing an online application used by users via client devices 130-136, including installs of an online application (e.g. mobile application, gaming application, mobile gaming application), facilitating user interactions, introducing features, and any other suitable operation. The server system 110 includes software components and databases that can be deployed at one or more data centers in one or more geographic locations. In certain instances, the server system 110 is, includes, or utilizes a content delivery network (CDN). The server system 110 may include one or more software components, including a pool generation component 121, a metric tracking component 122, a target identification component 123, and any other suitable component for fulfilling the methods discussed herein. The software components can include subcomponents that can execute on the same or on different individual data processing apparatus. The server system 110 databases can include a unit database 131 and a pool database 133, and any suitable number of other databases that are not illustrated in FIG. 1, such as a features database, a payments database, or an authentication database. The databases can reside in one or more physical storage systems. The software components and data will be further described below.

A client application, such as a web-based application, can be provided as an end-user application to allow users to interact with the server system 110 and with other users of the server system 110 via the application. The client application or components thereof can be accessed through a network 105 (e.g., the Internet) by users of client devices, such as a personal computer 130, a smart phone 132, a laptop computer 134, or a tablet computer 136. Other client devices are possible. Additionally, or alternatively, software components for the system 100 (e.g., the pool generation component 121, the metric tracking component 122, the target identification component 123) or any portions thereof can reside on or be used to perform operations on one or more client devices.

The metric tracking system 100 includes the pool generation component 121, the metric tracking component 122, and the target identification component 123 as being able to communicate with the unit database 131 and the pool database 133. The unit database 131 may include metrics associated with units that are being tracked by the metric tracking system 100, such as unit positions/distances, unit types, unit ratings, unit identifiers, and/or any other suitable metrics associated with units of the client application. The pool database 133 may include information about one or more pools of units generated by the metric tracking system 100. Such information may include the number of units in each pool of units, one or more rules associated with the pools of units, identifiers of the units in the pool of units, assigned priorities to the units of the pool of units, index numbers for the units in the pool of units, and/or any other suitable information.

The pool generation component 121 may be responsible for generating new pools of units as well as managing pools of units. The pool generation component 121 may be implemented by one or more human operators, or may be implemented as a machine-learning model that automatically performs one or more of the actions discussed herein. A pool of units may include a subset of the total number of units of a client application and may be used to efficiently track metrics for the subset of units. In embodiments, the pool generation component 121 may generate a new pool of units in response to a pool of units not existing for a particular unit of the client application. For example, in a video game application, if a unit is an air unit and no pool of units exists for air units, then the pool generation component 121 may generate a new pool of units for air units. In some embodiments, upon creating a new pool of units, the pool generation component 121 may identify all existing units of the client application to determine whether any of the existing units should be added to the new pool of units. In an embodiment, when a unit is removed from the client application, the pool generation component 121 may remove the unit from the one or more pools of units that the removed unit was a part of.

The pool generation component 121 may facilitate the creation of new pools of units by utilizing one or more rules to determine which units of a client application are included in the pool of units. For example, in a video game application the rules for a pool of units may indicate that the pool of units is to include land units from the video game application. In another example, in a navigation application, the rules for a first pool of units may indicate that the first pool of units is to include restaurants, a second pool of units is to include gas stations, a third pool of units is to include grocery stores, etc. In a further example, in a social media application, the rules for a pool of units may indicate that the pool of units is to include friends/connections of a user of the social media application. In an additional example, in an autonomous vehicle application, the rules for a first pool of units may indicate that the first pool of units is to include pedestrians, the rules for a second pool of units may indicate that the second pool of units is to include vehicles, etc. These rules may be implemented at the software level using software instructions.

The metric tracking component 122 may be responsible for tracking metrics of the units of one or more pools of units generated by pool generation component 121. The metric tracking component 122 may scan the units of the pool of units in a determined order to determine one or more metrics of the units. For example, the metric tracking component 122 may sequentially scan the units of the pool of units to determine the distance from each unit of a pool of units to a primary unit of the client application. In some embodiments, the metric tracking component 122 may assign different priority levels to the units within a pool of units. The priority levels may indicate how frequently the metric tracking component 122 determines metrics for each of the units. For example, the metric tracking component 122 may determine metrics for units assigned a high priority more frequently than units assigned with a low priority.

The target identification component 123 may be responsible for identifying target unit(s) for a primary unit of a client application. In a client application, a primary unit may have one or more target rules that are used to identify one or more pools of units that may contain a potential target unit. For example, the one or more target rules may indicate that the primary unit can only target land units. Accordingly, the target identification component 123 may identify pools of units that include land units as containing a potential target unit.

The primary unit may also have one or more target criteria that may be used to identify one or more target units for the primary unit. For example, a unit of a user (e.g., a primary unit) of a video game application may have target criteria that indicates the primary unit is to target the closest land unit. The target identification component 123 may select a target unit from the one or more pools of units based on the target criteria and the metrics of the units tracked by metric tracking component 122. For example, if the target criteria indicate that the target unit for the primary unit should be the closest unit from the pool of units, then the target identification component 123 may select the closest unit to the primary unit as the target unit. When the metric tracking component 122 determines metrics for a new unit of the pool of units, the target identification component 123 may compare the metric of the new unit to the metric of the currently selected target unit. If the metric for the new unit satisfies the target criteria, then the target identification component 123 may replace the currently selected target unit with the new unit as the target unit. For example, if the new unit is closer to the primary unit than the currently selected target unit, then the currently selected target unit may be replaced with the new unit as the target unit.

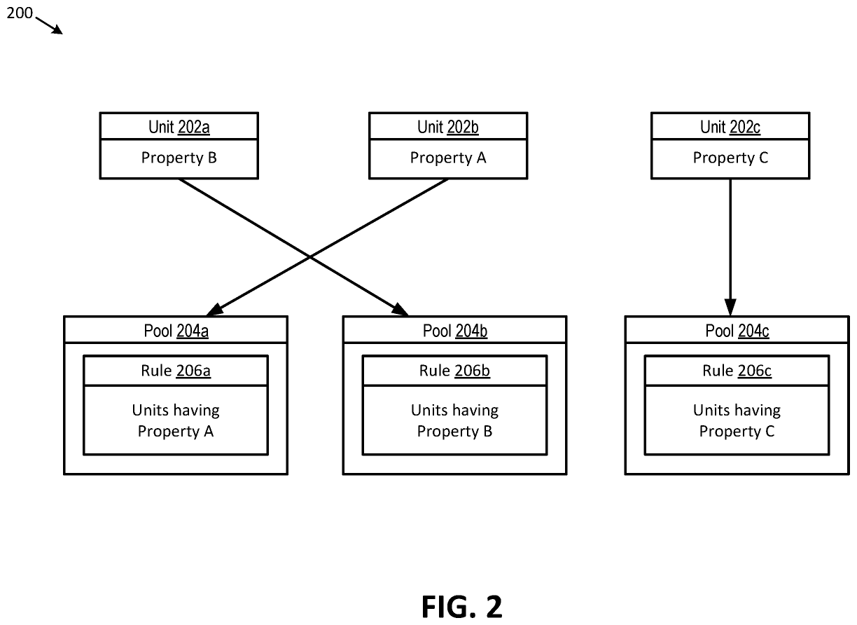

FIG. 2 is an illustration of an example of a metric tracking system assigning units of a client application 200 to pools of units, in accordance with embodiments of the disclosure. The client application 200 includes units 202a-c that correspond to units of the client application. In embodiments, units 202a-c may correspond to new units of the client application that have not been assigned to one or more pools of units. In some embodiments, units 202a-c may correspond to existing units that are to be relocated to one or more pools of units. Units 202a-c may have one or more properties that may be used to determine which pool the units are to be added to. The client application 200 further includes pools 204a-c of units (also referred to as “pools” hereafter) that correspond to different pools of units for the client application 200. Pools 204a-c each have a corresponding set of rules 206a-c. Rules 206a-c may specify which unit(s) of client application 200 are to be included in pools 204a-c, respectively. It should be noted that units 202a-c, pools 204a-c, and rules 206a-c are shown for illustrative purposes only and do not represent physical components of a metric tracking system.

Units 202a-c may be any types of units of a client application. For example, in a video game application, units 202a-c may be characters, vehicles, towers, etc. of the video game application. In another example, in a navigation application, units 202a-c may be restaurants, shops, gas stations, landmarks, etc. In a further example, in a social media application, units 202a-c may be other users of the social media application. In an additional example, for an autonomous vehicle application, units 202a-c may be pedestrians, vehicles, traffic signals, obstacles, etc.

Referring to FIG. 2, unit 202a has Property B, unit 202b has Property A, and unit 202c has Property C. Pool 204a includes rule 206a that indicates that units having property A are to be included in pool 204a. Pool 204b includes rule 206b that indicates that units having property B are to be included in pool 204b. Pool 204c includes rule 206c that indicates that units having property C are to be included in pool 204c. Because unit 202a has Property B, unit 202a may be added to pool 204b based on rule 206b indicating that units having Property B are to be included in pool 204b. Because unit 202b has Property A, unit 202b may be added to pool 204a based on rule 206a indicating that units having Property A are to be included in pool 204a. Because unit 202c has Property C, unit 202c may be added to pool 204c based on rule 206c indicating that units having Property C are to be included in pool 204c.

Although the units 202a-c of client application 200 are each shown having a single property, in embodiments units 202a-c may have any number of properties. Additionally, although pools 204a-c are each shown having a single rule (e.g., rules 206a-c), in embodiments pools 204a-c may have any number of associated rules.

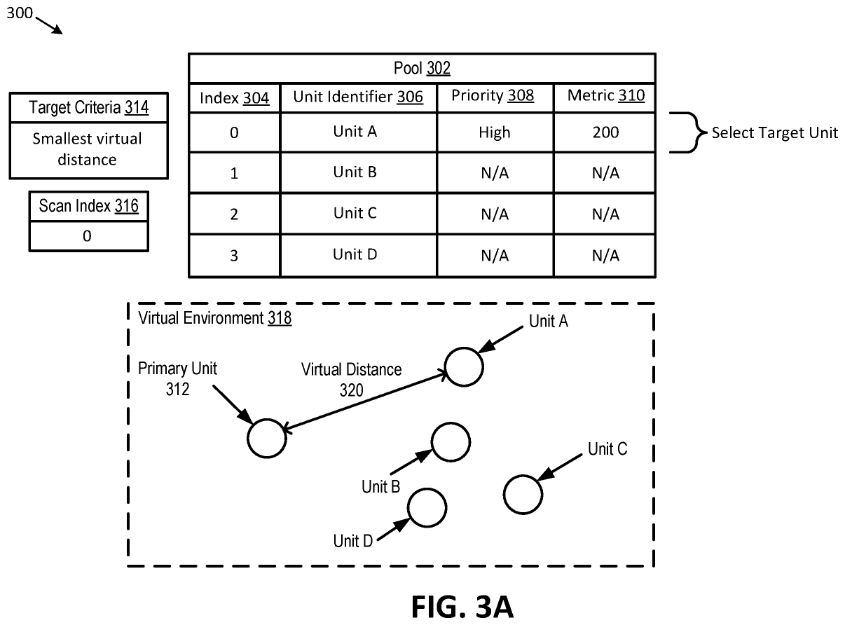

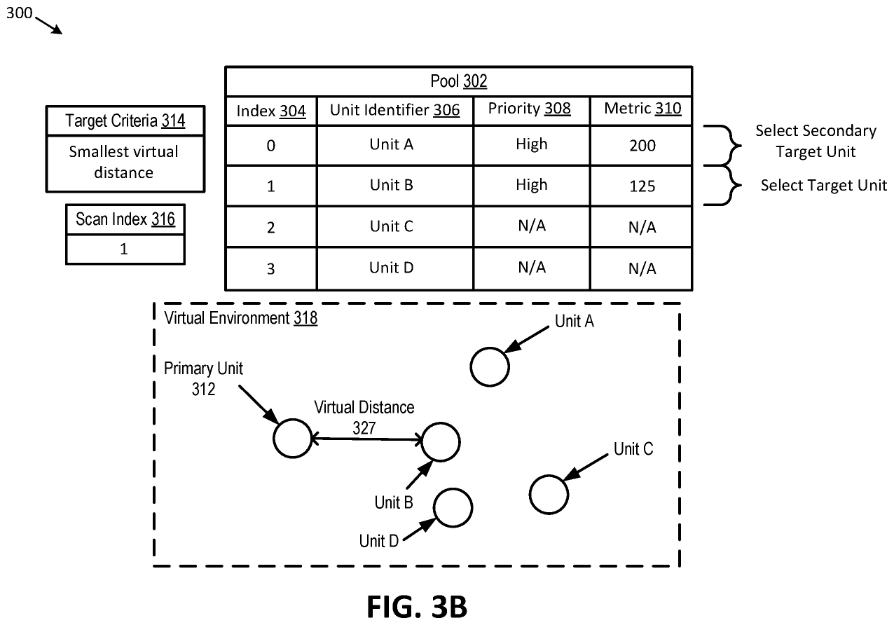

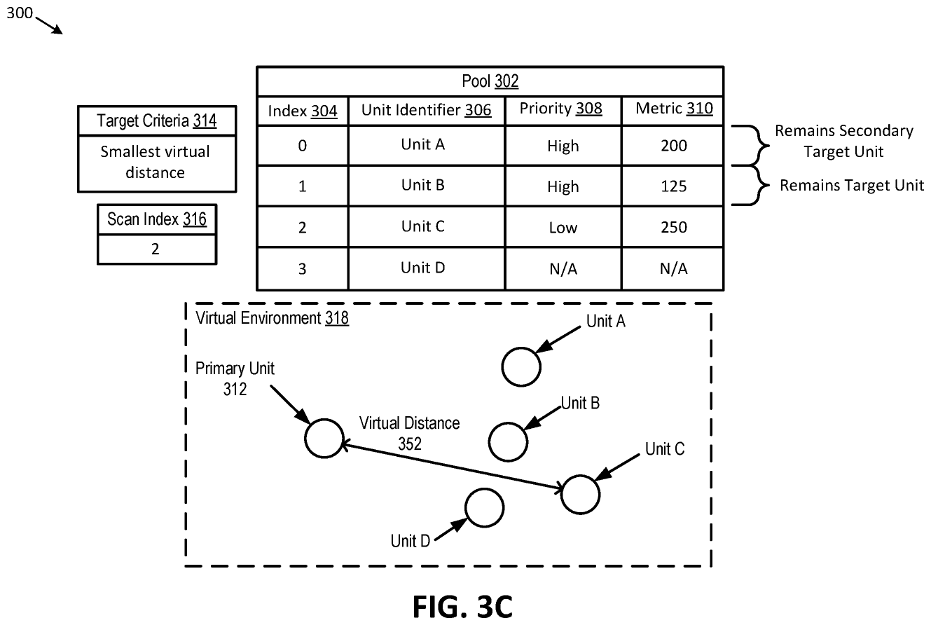

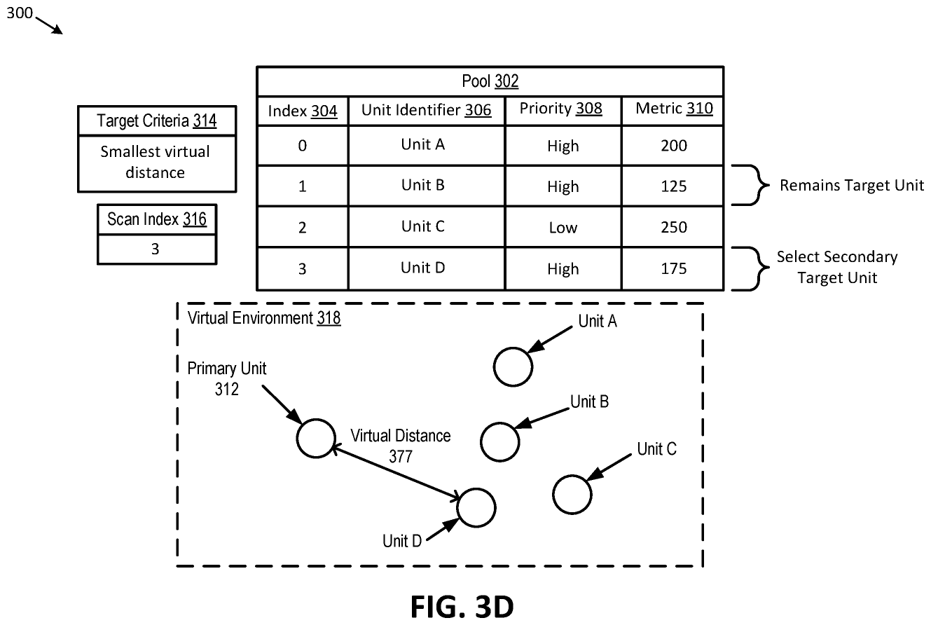

FIG. 3A is an illustration of an example of a metric tracking system tracking metrics of a first unit of a client application 300, in accordance with embodiments of the disclosure. The client application 300 includes a pool 302 of units of the client application. In some embodiments, pool 302 may have been previously identified as a pool that contains potential targets for a primary unit 312 of client application 300 based on one or more target rules associated with the primary unit 312, as previously described. In embodiments, the pool 302 may be a data structure including information associated with each of the units that have been added to pool 302. In some embodiments, the pool 302 may include an index 304 for each of the units of pool 302. The index 304 may be used by the metric tracking system to determine which unit of the pool 302 is to be scanned next by comparing the index 304 value to a scan index 316. The scan index 316 may indicate the corresponding index 304 for the next unit of pool 302 to be scanned by the metric tracking system. For example, if the scan index 316 has a value of 1, the metric tracking system may scan the unit having a corresponding index 304 value of 1. As previously described, the metric tracking system may scan units of the pool in a determined order to determine one or more metrics of the units. Accordingly, the metric tracking system may utilize the index 304 and the scan index 316 to scan units of the pool in the determined order.

In embodiments, the pool 302 may include a unit identifier 306 that may be used to identify a particular unit of pool 302. In some embodiments, units of pool 302 may be assigned a priority 308 that determines how often a unit is scanned by the metric tracking system. For example, a unit of pool 302 assigned a high priority may be scanned more often than a unit of pool 302 assigned a low priority. The pool 302 may include one or more metrics 310 associated with the units of pool 302 that are tracked by the metric tracking system. As previously described, metrics 310 may correspond to any numerical value(s) that may be associated with units of pool 302. Examples of metrics 310 that may be tracked include, but are not limited to, geographic positions, distances, ratings, travel times, speeds, velocities, or any other numerical values.

Referring to FIG. 3A, pool 302 includes Units A-D that each have an associated index 304, unit identifier 306, priority 308 and metric 310. In FIG. 3A, Units A-D may correspond to potential target units for primary unit 312 in a virtual environment 318. For example, Units A-D may correspond to units that are targetable by a user's character in a video game application. The metric 310 tracked for Units A-D may correspond to a virtual distance 320 between the primary unit 312 and each of Units A-D in the virtual environment 318. The scan index 316 in FIG. 3A has a value of 0, meaning the metric tracking system is to scan the unit having an index 304 value of 0. Accordingly, the metric tracking system may scan Unit A having an index value of 0 to determine that the virtual distance 320 between Unit A and the primary unit 312 is 200.

For illustrative purposes, Units B-D of pool 302 are being shown as newly added units to pool 302 that have not been scanned by the metric tracking system. Accordingly, Units B-D do not have corresponding metrics 310 because the metric tracking system has not scanned Units B-D to determine the virtual distances (e.g., metrics 310) between Units B-D and the primary unit 312.

As previously described, the primary unit 312 may have one or more target criteria 314 that may be used to select a target unit for primary unit 312. In FIG. 3A, the target criteria 314 indicates that the unit having the smallest virtual distance to primary unit 312 is to be selected as the target unit for primary unit 312. Accordingly, because Unit A is the only unit of pool 302 that has determined virtual distance 320 to primary unit 312, Unit A is selected as the target unit for primary unit 312.

In some embodiments, the metric tracking system may assign the priority 308 to a unit based on the tracked metrics associated with the units. For example, the metric tracking system may assign a high priority to units within a virtual distance of 200 of the primary unit 312 and a low priority to units outside of a virtual distance of 200 of the primary unit 312. Accordingly, units that are located closer to primary unit 312 may be scanned more frequently than units that are farther away from primary unit 312, potentially reducing the amount of time required to select the proper target unit for the primary unit 312. In embodiments, the priority 308 assigned to units of pool 302 may be provided by a user of the client application. In an embodiment, newly added units of pool 302 and/or client application 300 may initially be given a high priority to cause the newly added units to be scanned more quickly than units that have been previously scanned by the metric tracking system.

FIG. 3B is an illustration of an example of a metric tracking system tracking metrics of a second unit of a client application 300, in accordance with embodiments of the disclosure. Upon scanning Unit A in FIG. 3A, the scan index 316 may be updated based on the determined order for scanning the units of pool 302. For example, when sequentially scanning the units of pool 302, the scan index 316 may be incremented from a value of 0 to a value of 1. The metric tracking system may scan Unit B, having an index 304 value of 1, to determine that the virtual distance 327 between the primary unit 312 and Unit B in virtual environment 318 is 125.

Upon determining metric 310 for Unit B, the metric tracking system may compare the newly determined metric 310 for Unit B to the currently selected target unit (e.g., Unit A). Because the virtual distance 327 of Unit B is smaller than the virtual distance of Unit A, Unit B may replace Unit A as the selected target unit for primary unit 312. Additionally, because the virtual distance 327 is less than 200, the metric tracking system may assign a high priority to Unit B.

In some embodiments, the metric tracking system may also select a secondary target unit for primary unit 312. The secondary target unit may correspond to the next best target in pool 302 based on the target criteria 314. For example, the secondary target unit may correspond to the unit of pool 302 that has the second smallest virtual distance from primary unit 312. In the event that the selected target unit is no longer targetable by the primary unit 312, the secondary target unit may be selected as the new target unit. For example, in a video game application, if the target unit (e.g., Unit B) is destroyed or removed from the game, the secondary target unit (e.g., Unit A) may be selected as the new target unit.

FIG. 3C is an illustration of an example of a metric tracking system tracking metrics of a third unit of a client application 300, in accordance with embodiments of the disclosure. Upon scanning Unit B in FIG. 3B, the scan index 316 may be updated based on the determined order for scanning the units of pool 302. For example, when sequentially scanning the units of pool 302, the scan index 316 may be incremented from a value of 1 to a value of 2. The metric tracking system may scan Unit C, having an index 304 value of 2, to determine that the virtual distance 352 between the primary unit 312 and Unit C in virtual environment 318 is 250.

Upon determining metric 310 for Unit C, the metric tracking system may compare the newly determined metric 310 for Unit C to the currently selected target unit (e.g., Unit B) and the currently selected secondary target unit (e.g., Unit A). Because the virtual distance 352 of Unit C is greater than the virtual distance of Unit B and the virtual distance of Unit A, Unit B remains the target unit for primary unit 312 and Unit A remains the secondary target unit for primary unit 312. Additionally, because the virtual distance 352 is greater than 200, the metric tracking system may assign a low priority to Unit C.

FIG. 3D is an illustration of an example of a metric tracking system tracking metrics of a fourth unit of a client application 300, in accordance with embodiments of the disclosure. Upon scanning Unit C in FIG. 3C, the scan index 316 may be updated based on the determined order for scanning the units of pool 302. For example, when sequentially scanning the units of pool 302, the scan index 316 may be incremented from a value of 2 to a value of 3. The metric tracking system may scan Unit D, having an index 304 value of 3, to determine that the virtual distance 377 between the primary unit 312 and Unit D in virtual environment 318 is 175.

Upon determining metric 310 for Unit D, the metric tracking system may compare the newly determined metric 310 for Unit D to the currently selected target unit (e.g., Unit B) and the currently selected secondary target unit (e.g., Unit A). Because the virtual distance 377 of Unit C is greater than the virtual distance of Unit B, Unit B remains the target unit for primary unit 312. However, because the virtual distance 377 of Unit D is smaller than the virtual distance of Unit A, Unit D replaces Unit A as the secondary target unit for the primary unit 312. Additionally, because the virtual distance 377 is less than 200, the metric tracking system may assign a high priority to Unit D.

Once the units from pool 302 have been scanned, the metric tracking system may reset the scan index 316 to 0 and begin scanning Units A-D based on the determined order to update/track the metrics 310 of Units A-D, as previously described in FIGS. 3A-3D. This process may be iteratively performed to efficiently track metrics 310 and identify target unit(s) and/or secondary target unit(s) of primary unit 312 based on target criteria 314.

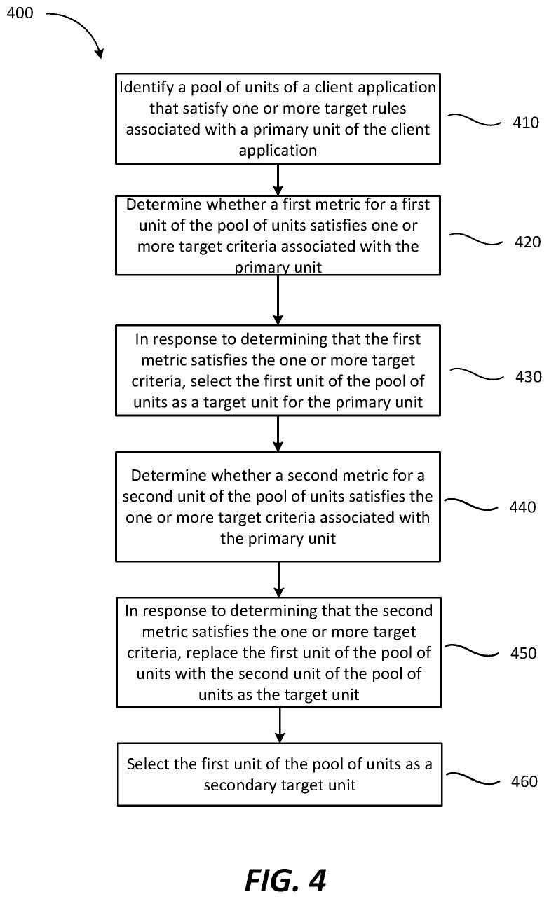

FIG. 4 is a block diagram illustrating an example method 400 of tracking metrics of a pool of units, in accordance with embodiments of the disclosure. In general, the method 400 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. For example, the processing logic may be implemented as pool generation component 121, metric tracking component 122 and/or target identification component 123.

Method 400 may begin at block 410, where the processing logic identifies a pool of units of a client application that satisfy one or more target rules associated with a primary unit of the client application. For example, in a video game application, the one or more target rules of a primary unit may indicate that the primary unit can only target land units. Accordingly, the processing logic may identify a pool of units that includes land units. In another example, in a navigation application, the one or more target rules of a primary unit may indicate that the primary unit can only target restaurants. Accordingly, the processing logic may identify a pool of units that includes restaurants.

At block 420, the processing logic determines whether a first metric for a first unit of the pool of units satisfies one or more target criteria associated with the primary unit. For example, if the one or more target criteria indicate that a target unit is to have the smallest virtual distance to the primary unit, then the processing logic may determine if the virtual distance between the first unit and the primary unit satisfies the target criteria.

At block 430, in response to determining that the first metric satisfies the target criteria, the processing logic selects the first unit of the pool of units as a target unit for the primary unit. For example, if the processing logic determines that the first unit has the smallest virtual distance to the primary unit, then the processing logic may select the first unit as a target unit for the primary unit.

At block 440, the processing logic determines whether a second metric for a second unit of the pool of units satisfies the one or more target criteria associated with the primary unit.

At block 450, in response to determining that the second metric satisfies the one or more target criteria, the processing logic replaces the first unit of the pool of units with the second unit of the pool of units as the target unit. For example, if the virtual distance between the second unit and the primary unit is smaller than the virtual distance between the first unit and the primary unit, then the second unit may replace the first unit and the target unit.

At block 460, the processing logic selects the first unit of the pool of units as a secondary target unit.

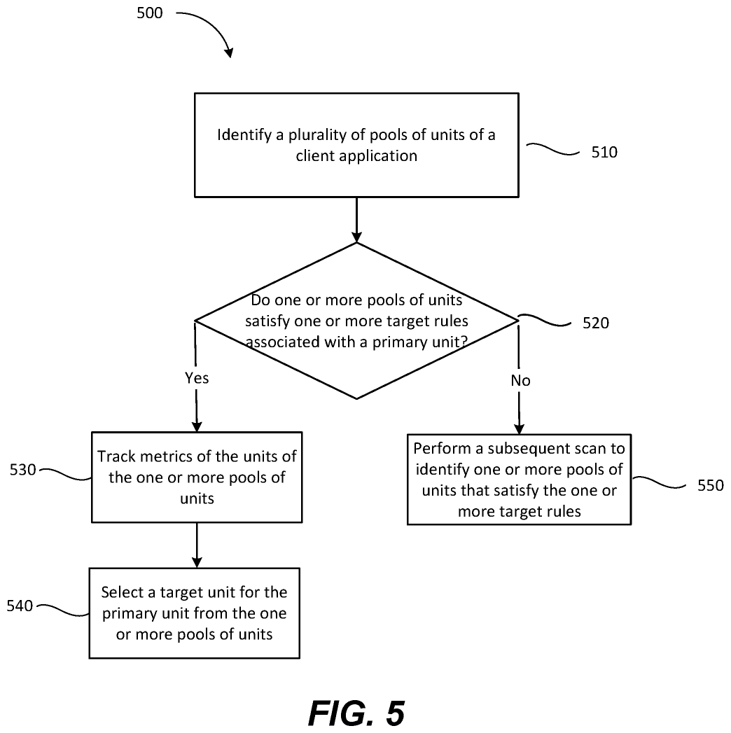

FIG. 5 is a block diagram illustrating an example method 500 of identifying one or more pools of units of a client application based on target rules of a primary unit, in accordance with embodiments of the disclosure. In general, the method 500 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. For example, the processing logic may be implemented as pool generation component 121, metric tracking component 122 and/or target identification component 123.

Method 500 may begin at block 510, where the processing logic identifies a plurality of pools of units of a client application.

At block 520, the processing logic determines if one or more pools of units of the plurality of pools satisfy one or more target rules associated with a primary unit. For example, if the one or more target rules of a video game application indicate that the primary unit can only attack land units, then the processing logic may determine if any of the plurality of pools of units include land units.

If one or more pools of units satisfy the one or more target rules of the primary unit, then at block 530 the processing logic tracks metrics of the units of the one or more pools of units. For example, the processing logic may track virtual distances between each of the units of the one or more pools of units and the primary unit.

At block 540, the processing logic selects a target unit for the primary unit from the one or more pools of units. In embodiments, the processing logic may select the target unit from the one or more pools of units based on one or more target criteria of the primary unit, as previously described.

If none of the plurality of pools of units satisfy the one or more target rules associated with the primary unit, at block 550 the processing logic performs a subsequent scan of the plurality of pools to identify one or more pools that satisfy the one or more target rules. For example, if none of the plurality of pools of a video game application include land units, then the processing logic may perform a subsequent scan of the plurality of pools to determine if any land units have been added to one of the plurality of pools and/or if a new pool has been generated that includes land units.

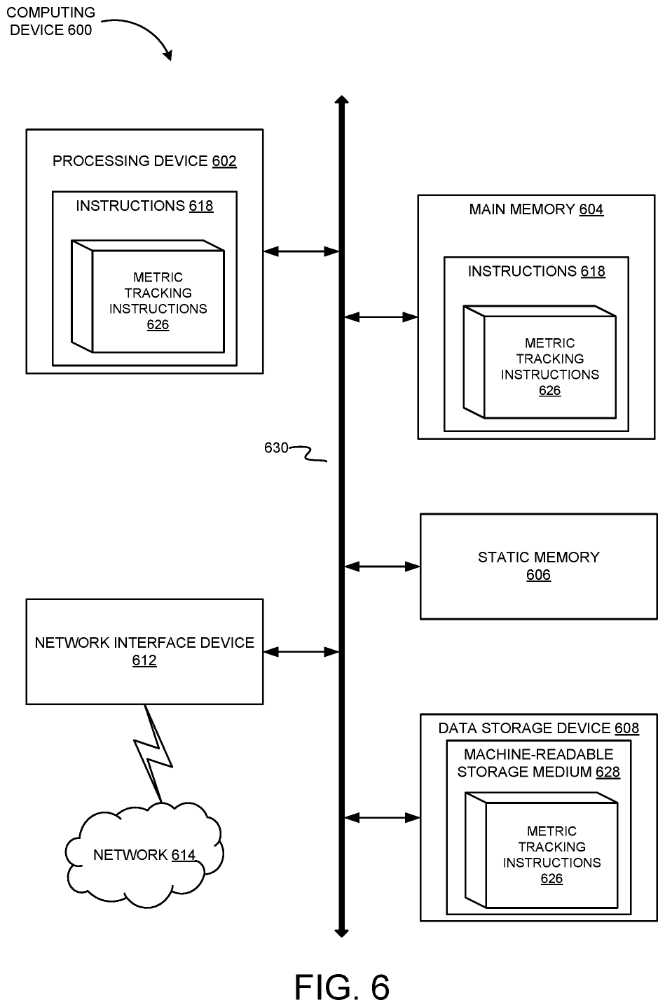

FIG. 6 is a block diagram of an example computing device 600 that may perform one or more of the operations described herein, in accordance with the present embodiments. The computing device 600 may be connected to other computing devices in a LAN, an intranet, an extranet, and/or the Internet. The computing device 600 may operate in the capacity of a server machine in client-server network environment or in the capacity of a client in a peer-to-peer network environment. The computing device 600 may be provided by a personal computer (PC), a set-top box (STB), a server, a network router, switch or bridge, or any machine capable of executing a set of instructions (sequential or otherwise) that specify actions to be taken by that machine. Further, while only a single computing device 600 is illustrated, the term “computing device” shall also be taken to include any collection of computing devices that individually or jointly execute a set (or multiple sets) of instructions to perform the methods discussed herein.

The example computing device 600 may include a computer processing device (e.g., a general purpose processor, ASIC, etc.) 602, a main memory 604, a static memory 606 (e.g., flash memory and a data storage device 608), which may communicate with each other via a bus 630. The computer processing device 602 may be provided by one or more general-purpose processing devices such as a microprocessor, central processing unit, or the like. In an illustrative example, computer processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. The computer processing device 602 may also comprise one or more special-purpose processing devices such as an application specific integrated circuit (ASIC), a field programmable gate array (FPGA), a digital signal processor (DSP), network processor, or the like. The computer processing device 602 may be configured to execute the operations described herein, in accordance with one or more aspects of the present disclosure, for performing the operations and steps discussed herein.

The computing device 600 may further include a network interface device 612, which may communicate with a network 614. The data storage device 608 may include a machine-readable storage medium 628 on which may be stored one or more sets of instructions, e.g., instructions for carrying out the operations described herein, in accordance with one or more aspects of the present disclosure. Instructions 618 implementing metric tracking instructions 626 may also reside, completely or at least partially, within main memory 604 and/or within computer processing device 602 during execution thereof by the computing device 600, main memory 604 and computer processing device 602 also constituting computer-readable media. The instructions may further be transmitted or received over the network 614 via the network interface device 612.

While machine-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer processing device, a computer, a system on a chip, or multiple ones, or combinations, of the foregoing. A computer processing device may include one or more processors which can include special purpose logic circuitry, e.g., an FPGA (field programmable gate array) or an ASIC (application specific integrated circuit), a central processing unit (CPU), a multi-core processor, etc. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative, procedural, or functional languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto optical disks, optical disks, or solid state drives. However, a computer need not have such devices. Moreover, a computer can be embedded in another device, e.g., a smart phone, a mobile audio or media player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method, comprising:
identifying a pool of units of a client application that satisfy one or more targeting rules associated with a primary unit, wherein the pool of units comprises a subset of a total number of units of the client application;
determining, by a computer processing device, whether a first metric for a first unit of the pool of units satisfies one or more target criteria associated with the primary unit; and
in response to determining that the first metric satisfies the one or more target criteria, selecting the first unit of the pool of units as a target unit for the primary unit.

2. The method of claim 1, further comprising:
determining whether a second metric for a second unit of the pool of units satisfies the one or more target criteria associated with the primary unit; and
in response to determining that the second metric satisfies the one or more target criteria, replacing the first unit of the pool of units with the second unit of the pool of units as the target unit.

3. The method of claim 2, further comprising:
selecting the first unit of the pool of units as a secondary target unit.

4. The method of claim 1, wherein the first metric corresponds to a virtual distance between the first unit of the pool of units and the primary unit.

5. The method of claim 1, further comprising:
sequentially determining whether corresponding metrics for the pool of units satisfy the one or more target criteria based on a determined order.

6. The method of claim 1, further comprising:
receiving a new unit to be added to the client application;
determining whether the new unit satisfies one or more rules associated with the pool of units; and
in response to determining that the new unit satisfies the one or more rules associated with the pool of units, adding the new unit to the pool of units.

7. The method of claim 1, further comprising:
receiving a new unit to be added to the client application;
determining whether the new unit satisfies one or more rules associated with the pool of units; and
in response to determining that the new unit does not satisfy the one or more rules associated with the pool of units, generating a new pool of units for the new unit.

8. The method of claim 1, further comprising:
assigning a first priority level to a first set of units of the pool of units and a second priority level to a second set of units of the pool of units.

9. The method of claim 1, wherein the client application comprises at least one of a video game application, a navigation application, a social media application, or an autonomous vehicle application.

10. A system, comprising:
a memory; and
a computer processing device, operatively coupled to the memory, to:
identify a pool of units of a client application that satisfy one or more targeting rules associated with a primary unit, wherein the pool of units comprises a subset of a total number of units of the client application;
determine whether a first metric for a first unit of the pool of units satisfies one or more target criteria associated with the primary unit; and
in response to determining that the first metric satisfies the one or more target criteria, select the first unit of the pool of units as a target unit for the primary unit.

11. The system of claim 10, wherein the computer processing device is further to:
determine whether a second metric for a second unit of the pool of units satisfies the one or more target criteria associated with the primary unit; and
in response to determining that the second metric satisfies the one or more target criteria, replace the first unit of the pool of units with the second unit of the pool of units as the target unit.

12. The system of claim 11, wherein the computer processing device is further to:
select the first unit of the pool of units as a secondary target unit.

13. The system of claim 10, wherein the first metric corresponds to a virtual distance between the first unit of the pool of units and the primary unit.

14. The system of claim 10, wherein the computer processing device is further to:
sequentially determine whether corresponding metrics for the pool of units satisfy the one or more target criteria based on a determined order.

15. The system of claim 10, wherein the computer processing device is further to:
receive a new unit to be added to the client application;
determine whether the new unit satisfies one or more rules associated with the pool of units; and
in response to determining that the new unit satisfies the one or more rules associated with the pool of units, add the new unit to the pool of units.

16. The system of claim 10, wherein the computer processing device is further to:
assign a first priority level to a first set of units of the pool of units and a second priority level to a second set of units of the pool of units.

17. A non-transitory computer-readable medium having instructions stored thereon that, when executed by a computer processing device, cause the computer processing device to:
identify a pool of units of a client application that satisfy one or more targeting rules associated with a primary unit, wherein the pool of units comprises a subset of a total number of units of the client application;
determine, by the computer processing device, whether a first metric for a first unit of the pool of units satisfies one or more target criteria associated with the primary unit; and
in response to determining that the first metric satisfies the one or more target criteria, select the first unit of the pool of units as a target unit for the primary unit.

18. The non-transitory computer-readable medium of claim 17, wherein the computer processing device is further to:
determine whether a second metric for a second unit of the pool of units satisfies the one or more target criteria associated with the primary unit; and
in response to determining that the second metric satisfies the one or more target criteria, replace the first unit of the pool of units with the second unit of the pool of units as the target unit.

19. The non-transitory computer-readable medium of claim 17, wherein the computer processing device is further to:
sequentially determine whether corresponding metrics for the pool of units satisfy the one or more target criteria based on a determined order.

20. The non-transitory computer-readable medium of claim 17, wherein the computer processing device is further to:
receive a new unit to be added to the client application;
determine whether the new unit satisfies one or more rules associated with the pool of units; and
in response to determining that the new unit satisfies the one or more rules associated with the pool of units, add the new unit to the pool of units.
